(19) United States
(12) Patent Application Publication
(10) Pub. No.: US 2009/0222876 A1
(43) Pub. Date: Sep. 3, 2009

(54) POSITIVE MULTI-SUBSYSTEMS SECURITY MONITORING (PMS-SM)

(76) Inventors: Maor Goldberg, Tel Aviv (IL); Ronny Dukat, Tel Aviv (IL); Eran Leih, Tel Aviv (IL); Shlomi Wexler, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 12/038,935

(22) Filed: Feb. 28, 2008

Related U.S. Application Data
(63) Continuation-in-part of application No. 12/038,822, filed on Feb. 28, 2008.

(51) Int. Cl. G06F 21/00

(52) U.S. Cl. 726/1

(57) ABSTRACT

A system for Positive Multi-Subsystems—Security Monitoring providing for the monitoring of security events of a business organization comprising business assets, wherein the events are monitored according to a positively stated policy that is created, managed and controlled by Multiple Sub-Systems Meta Security Policy. The system includes Policy Connectors, wherein each PC has a specific set of rules and relevant data and an event collector comprising centralized event collector software, wherein the event collector collects security events, and wherein each security event is created in the PMS-SM system using MSSMSP. Each event arises from an application. The system also includes security events which include Business Asset Monitor events. A BAM event represents user activity against a specific business asset and Security data that is queried from the various security sub-systems using the PC's and a Security policy of MSSMSP. The system enables positive, centralized security monitoring.

### CROSS-REFERENCE TO RELATED APPLICATIONS

This application is a continuation-in-part of co-pending U.S. patent application Ser. No. 12/038,822, filed Feb. 28, 2008, entitled “A Method and System for Multiple Sub-Systems Meta Security Policy,” which is assigned to the assignee of the present patent application, and is incorporated herein by reference.

### FIELD OF THE INVENTION

The present invention generally relates to security management, and more particularly to a method and system for positive multi-subsystems—security monitoring (PMS-SM).

### BACKGROUND OF THE INVENTION

The world of Information Security has come a long way since the introduction of basic security sub-systems such as Anti-Virus systems and Firewall systems. The growth of these sub-systems, together with the growth of IT complexity in enterprises today have created the need for a much simpler, easier to maintain and more effective security monitoring solution. Information security is about taking care of the information's confidentiality, integrity and availability of information that is valuable for the organization. When leaked, manipulated or denied access to, this may damage the organization. As big as the damage that the organization may suffer, the Information at hand is classified as more important and critical.

Information today is rarely stored as physical documents and drawings in cabinets and safes, but is more likely stored in digital format, whether using a non-structured format, such as Microsoft Office files, or using a structured format, such as records inside the organization's Customers Relations Management (CRM) system. This, together with the digitalization and Internet revolutions, has led to a dramatic increase in technological threats on an organization's information assets coming from inside and outside the organization.

The first information security “Threat”, as we know it, was the computer virus, which in turn led to the rise of the first information security system, the “Anti-Virus.” Today it is quite normal to hear about new security threats, quickly followed by new Information Security systems. Recently, information security sub-systems have become an integral part of any enterprise organization's IT infrastructure. The amount of the security sub-systems In the organization is growing rapidly and so is the amount of the Security Events these system generate.

A security event is a set of records, usually written to a log file, which contain security related data. This data can be a security alert, generated by an Intrusion Detection System, for example, or a security notification generated when an illegal operation was prevented successfully by a security sub-system, for example. The security events are valuable information for security personnel in the enterprise. In its simplest form a security event record indicates a security issue, which requires handling or mitigation of some sort. In its most complex form, merely a correlation of many security event records from more then one security sub-system indicates an issue which requires mitigation.

For these reasons, security events need to be monitored.

In the past, by having only one security sub-system, i.e. a Main Frame computer security sub-system, monitoring could be done manually. In most enterprises special “Security Auditors” were dedicated for handling this task. Today, since the amount of security sub-systems and the amount and size of its data are growing rapidly, it has become impossible for humans to manually process it. A technological solution for this problem was strongly needed.

FIG. 1 is a prior art schematic illustration of Security Information and Event Management. Security vendors realize that indeed a technological solution is needed and so has begun the era of the Security Information Management (SIM) solutions or Security Information and Event Management (SIEM) 110.

All of these solutions are based upon the same schema: collect all security records to a central repository; analyze 130 the collected data according to user-defined rules; and report 140 when certain rules are met. The names of these processes might change from one vendor solution to another but they all act upon this basic schema, as shown in prior art FIG. 1. As mentioned above, the first stage of Security Information Management is to have the event collectors 120 collect the security information. This stage is usually done by a specific vendor device or software that can connect to the vendor's security sub-system. The connection is usually made to the sub-system's log file in order to collect all log records.

It is important to understand that log files of security sub-systems were originally created for the use of system administrators to help in handling technical issues, monitor the sub-system's health, etc. The nature of these log records is long and complex with a lot of technical data. These log records refer only to their own sub-systems, with no correlation or understanding of other related systems. More than that, when dealing with user activity, these log records rarely have any understanding of the logical transactions being performed by the user.

After collecting the log records to the central repository, the analyze 130 stage begins. Each record is checked against a policy that contains a list of invalid situations. For instance, the policy might state that if a certain log record is written to a certain log file 5 times within 1 minute something wrong might have happened, this method is called event aggregation. Another method is event correlation. With event correlation, the policy can state that if a certain event from a specific sub-system is written to a log file with some correlation to one or more events from another security system, the analyzing engine 130 can conclude that something wrong might have happened.

FIG. 2 is a prior art schematic illustration of Event Aggregation and Correlation. The two steps of event aggregation 210 and event correlation 220 comprise the main method for Security Information Management systems to search for negative patterns in the security systems logs. Even with other methods to analyze the events, besides event correlation and event aggregation, the main paradigm remains unchanged: The policy is a list of invalid situations. Event aggregation 210 and correlation 220 enables reduction of the number of security events that need to be addressed, as illustrated in Table I below:

TABLE I

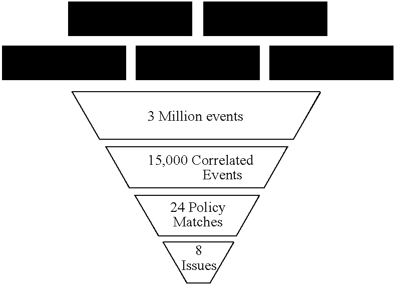

From information security's point of view, the negative monitoring paradigm is a bad paradigm. It is practically impossible to guess, up-front, all of the invalid situations that might ever happen, as it is impossible to guess the hacker's next move or new innovative hacking technologies.

Positive security monitoring is making sure that only authorized actions are allowed to be executed. Positive security will state a list of valid actions or events and make sure that only these actions and no others execute. In short, positive security will say: “this and that are allowed and all the rest are not” where Negative security will say: “this and that are not allowed, all the rest is good.”

Therefore, positive security, as a concept and by design, is much more secured. It is always much better to state the few valid situations than try to guess the numerous invalid ones. Most of today's security sub-systems operate by this schema, though overall security monitoring systems do not.

Thus, it would be desirable to provide a method for need for a much simpler, easier to maintain and more effective security monitoring solution.

### SUMMARY OF THE INVENTION

Accordingly, it is a principal object of the present invention to provide a method for Positive Multi-Subsystems—Security Monitoring (PMS-SM), which enables monitoring of security events according to a positively stated policy that is created, managed and correlated with the various security sub-system policies using MSSMSP.

It is another principal object of the present invention to provide a method for a simpler, easier to maintain and more effective security monitoring solution.

It is one other principal object of the present invention to enable the Chief Security Officer (CSO) to focus on creating a business-oriented security policy, while positively defining the behavior allowed, and have PMS-SM automatically handle all violations.

It is one further principal object of the present invention to coordinate with MSSMSP to reduce the time and resources needed in order to maintain a highly effective information security policy, one which understands the business assets and various transactions in the enterprise.

A system for Positive Multi-Subsystems—Security Monitoring (PMS-SM) is disclosed for providing the monitoring of security events of a business organization comprising business assets, wherein the events are monitored according to a positively stated policy that is created, managed and controlled by Multiple Sub-Systems Meta Security Policy (MSSMSP). The system includes Policy Connectors (PC's), wherein each PC has a specific set of rules and relevant data and an event collector comprising centralized event collector software, wherein the event collector collects security events, and wherein each security event is created in the PMS-SM system using MSSMSP, and wherein each event arises from an application. The system also includes security events which include Business Asset Monitors (BAM's), such that a BAM event represents a user activity against a specific business asset and Security data that is queried from the various security sub-systems using said PC's and a Security policy of Multiple Sub-Systems Meta Security Policy (MSSMSP), thereby enabling positive, centralized security monitoring.

Multiple Sub-Systems Meta Security Policy (“MSSMSP”) is a technology concept which enables the creation, management and control of one central Security Policy which is automatically correlated with the various security sub-systems policies in the enterprise.

PMS-SM is a method to positively monitor security. PMS-SM is using MSSMSP to build a positive security policy and uses that policy to monitor violations of Security events.

The Security event with PMS-SM is a combination of two entities. The first is a Business Asset Monitor (BAM) event of MSSMSP that represents a user activity against a certain business asset. The second is the security data that is queried from the various security sub-systems using the Policy Connectors (PC's). These two entities, together, represent a security event in the world of PMS-SM.

The security policy is a Positive security, thus enabling the checking of events against positively stated rules to enable positive security monitoring.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a prior art schematic illustration of Security Information and Event Management;

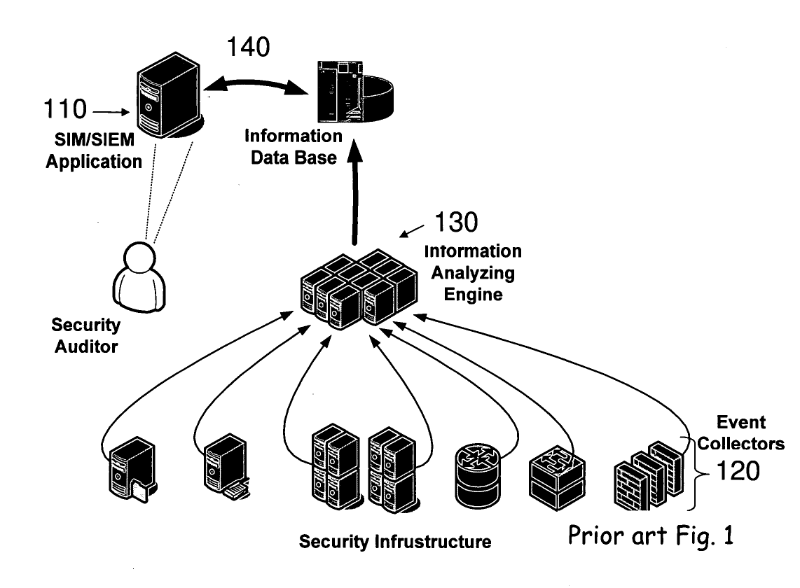

FIG. 2 is a prior art schematic illustration of Event Aggregation and Correlation;

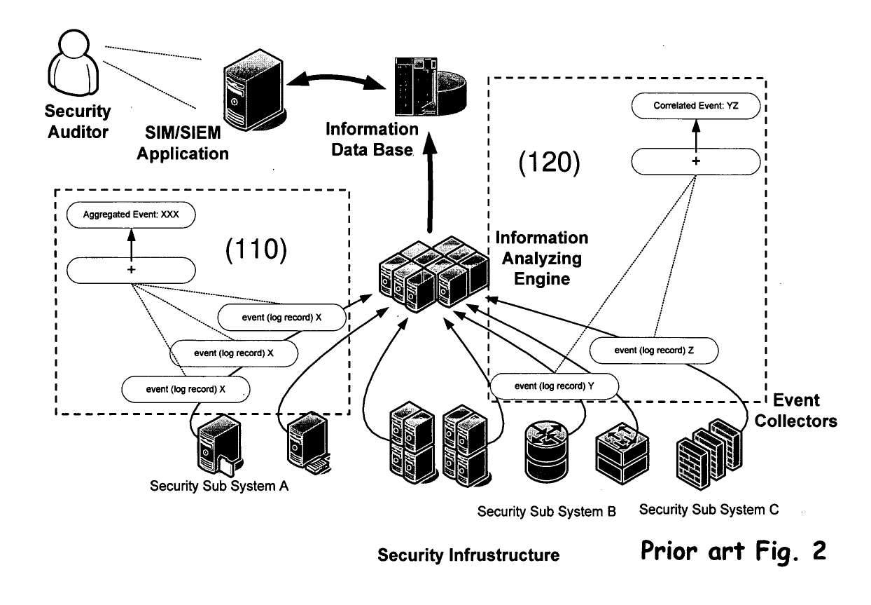

FIG. 3 is a schematic block diagram illustrating Positive Multi-Subsystems—Security Monitoring (PMS-SM), constructed according to the principles of the present invention;

FIG. 4 is a schematic flow diagram illustrating Positive Multi-Subsystems—Security Monitoring (PMS-SM) system operation, constructed according to the principles of the present invention; and

FIG. 5 is a schematic diagram illustrating the Rule Record Format for Positive Multi-Subsystems—Security Monitoring (PMS-SM), constructed according to the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

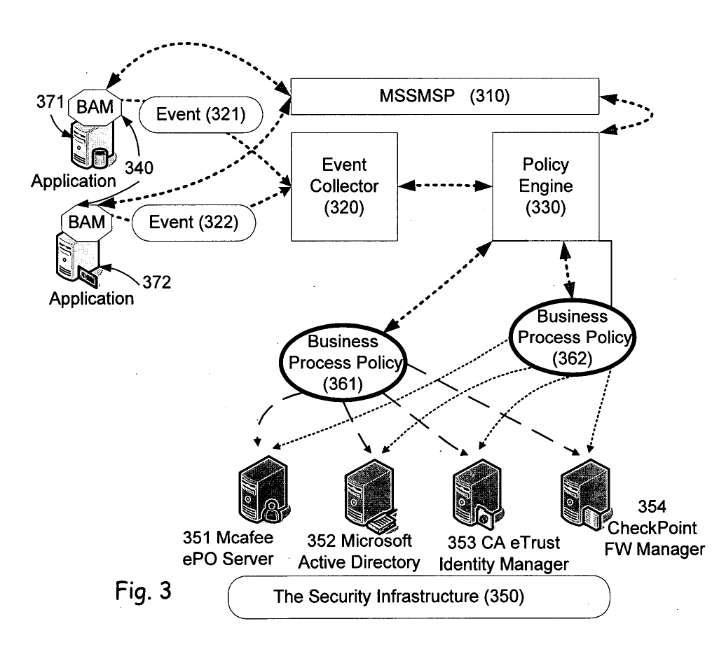

FIG. 3 is a schematic block diagram illustrating Positive Multi-Subsystems—Security Monitoring (PMS-SM), constructed according to the principles of the present invention. As described earlier, PMS-SM is a method to positively monitor security events. PMS-SM is a system comprising 3 building blocks: Multiple Sub-Systems Meta Security Policy (MSSMSP) 310, Event Collector 320 and a Policy Engine 330.

After a policy is defined using MSSMSP 310, the Business Asset Monitors (BAM's) 340 will send events 321 and 322 to event collector 320. Event collector 320 comprises centralized event collector software, which collects events from BAM's 340, enriches the event with security information from the security infrastructure 350 using the Policy Connectors (PC's) and transfers the enriched data to policy engine 330. Security sub-systems represented by security infrastructure 350 in the exemplary organization of FIG. 3 include a McAfee ePO server 351, a MicroSoft Active Directory™ 352, a CA eTrust™ Identity Manager 353 and a CheckPoint™ FW Manager 354. The security sub-systems are connected to Policy Engine 330 by Business Process Policies 361 and 362.

Policy engine 330 will check, using MSSMSP 310, if the event complies with any of the allowed situations for that application, and will mitigate the event source if not. The event was sent from a specific application monitor, for example event 321 from application 371 or event 322 from application 372.

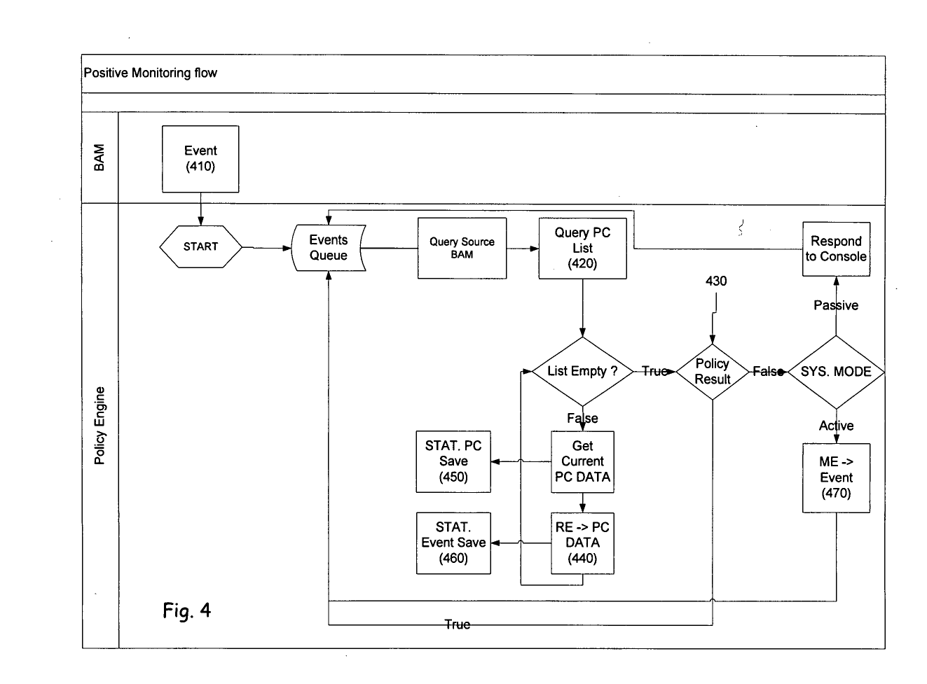

FIG. 4 is a schematic flow diagram illustrating Positive Multi-Subsystems—Security Monitoring (PMS-SM) system operation, constructed according to the principles of the present invention. The Security event with PMS-SM is a combination of two entities. The first is a Business Asset Monitor (BAM) event 410 of MSSMSP that represents a user activity against a certain business asset. The second is the security data that is queried from the various security sub-systems using the Policy Connectors (PC's) 420. The security event is created in the PMS-SM system using MSSMSP. After the event is created, the Policy Engine (PE) will check if the event complies with the security policy 430. This is done by checking each Policy Connector (PC) data against its specific set of rules using a Rules Engine (RE) 440. For each PC data result a Statistical Record is saved (STAT) 450. Another statistical record is saved for the event 460, which is the aggregated result of the PC data.

The system will mitigate the event using the Mitigation Engine (ME) 470 or just report an error according to the user's decision 430, but an error is reported only if the event result was False.

Positive security is achieved by the design of the system and by its method of operation: The rules for each PC are rules that positively state a list of situations 420, wherein at least one of them must exist for the event to be triggered. Rules Engine (RE) 440 can analyze each event and verify if that event complies with the policy.

Each rule is built from list of PC's 420, each with his own set of rules (PC-Rules), as illustrated as a Rules Record Example in TABLE II below.

TABLE II

| PC - | | PC - | | | |
|---|---|---|---|---|---|
| Symantec | PC - | Active | BAM | Asset | Rule |
| EPS | Checkpoint | Directory | Type | Name | Number |
| policy: No | Group: DBA | Smart card: | Terminal | ERP | 1 |
| USB | LAN | yes | Services | | |
| | | Group: | | | |
| | | DBA | | | |
| Policy: | Group: SAP | Group: | IIS | ERP | 2 |
| Level 0 | Users | SAP User | | | |

(Italic formatted data is PSM-MS related data while the other data is MSSP-MSP data)

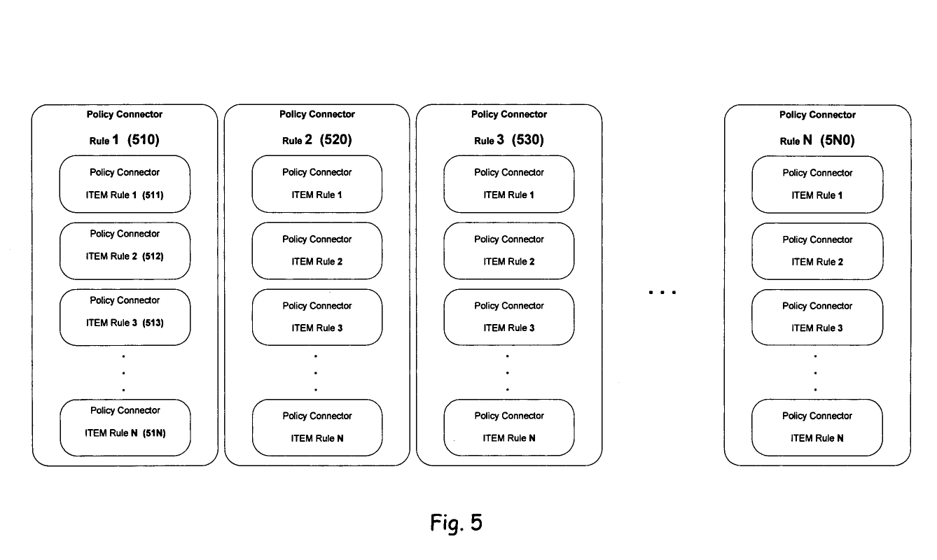

FIG. 5 is a schematic diagram illustrating the Rule Record Format for Positive Multi-Subsystems—Security Monitoring (PMS-SM), constructed according to the principles of the present invention. The PMS-SM Policy is a set of Rules associated with a specific BAM. Thus, each Business Asset declared with MSSM-SP has its one positive policy. Since the policy is built on a set of rules, it is important to understand the Rule format in order to fully understand how to achieve positive multi sub-system security monitoring (PMS-SM).

Since a PMS-SM Security Event is a set of PC data each Rules 510, 520, 530, . . . And 5N0, for example, it must contain some reference to each item of the PC data. Thus, each Rule contains a set of Policy Connector Rules (PC Rules), one for each PC data. For example Rule 1 510 contains PC rules 511, 512, 513, . . . , and 51N.

An event can comply with a rule only if all of its PC-Data items comply with their corresponding PC-Rules as in the following Boolean equation:

EVENT_RESULT=PC-RULE 1 Result AND PC-RULE 2 Result AND . . . PC-RULE N Result

Each PC-RULE is built of a PC ITEM Rule set. Each PC-ITEM Rule is a regular expression that states the allowed data for a specific field (ITEM) in the Policy Connector schema. For example, in Table II above, rule 1 shows two PC-ITEM Rules for the Active Directory PC, one for the field “smart-card” and one for the field “Group.”. The first expression in that example states that the field “smart-card” must contain the data “yes” and the field “Group” must contain the data “SAP User.”

For a PC-RULE to comply, all of its PC-ITEM rules must comply, as the following equation shows:

PC_RULE_RESULT=PC-ITEM RULE 1 Result AND PC-ITEM RULE 2 Result AND . . . PC-ITEM RULE N Result

This format enables a positive statement of security situations that each BAM related event must meet in order to be considered valid. This is the essence of PMS-SM.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A system for Positive Multi-Subsystems—Security Monitoring (PMS-SM) providing for the monitoring of security events of a business organization comprising business assets, wherein the events are monitored according to a positively stated policy that is created, managed and controlled by Multiple Sub-Systems Meta Security Policy (MSSMSP), the system comprising:
Policy Connectors (PC's), wherein each PC has a specific set of rules and relevant data;
an event collector comprising centralized event collector software, wherein said event collector collects security events, and wherein each security event is created in the PMS-SM system using MSSMSP, and wherein each event arises from an application; and
at least one security event comprising:
at least one Business Asset Monitor (BAM) event of MSSMSP, such that said BAM event represents a user activity against a specific business asset;
Security data that is queried from the various security sub-systems using said PC's; and
a Security policy of Multiple Sub-Systems Meta Security Policy (MSSMSP),
whereby said system enables positive, centralized security monitoring.

2. The system of claim 1, further comprising a security infrastructure comprising Security sub-systems.

3. The system of claim 1, further comprising a policy engine.

4. The system of claim 1, further comprising a Rules Engine (RE) for checking each PC data against its specific set of rules using

5. The system of claim 1, wherein policy engine uses said MSSMSP 310 to check whether said at least one security event complies with any of the allowed situations for that application, and will mitigate the event source if not.

6. The system of claim 1, wherein said security event is sent from a specific BAM.

7. The system of claim 3, wherein said event collector comprises centralized event collector software, and wherein said centralized event collector software collects events from said at least one BAM, enriches the events with security information from said security infrastructure using said PC's and transfers the enriched information to policy engine.

8. The system of claim 1, wherein PMS-SM automatically handles all violations.

9. A method for providing Positive Multi-Subsystems—Security Monitoring (PMS-SM) monitoring of a plurality of security events according to a positively stated policy that is created, managed and controlled by MSSMSP, the method comprising:
defining a security policy using MSSMSP;
sending at least one of the plurality of security events to an event collector having event collection software provided to perform the steps of:
collecting the at least one of the plurality of security events from at least one Business Asset Monitor (BAM) event of MSSMSP, such that said BAM event represents a user activity against a specific business asset;
enriching each of the at least one of the plurality of security events with security information from the security infrastructure using at least one PC; and
transferring said enriched data to the policy engine;
positively stating rules; and
checking each of the plurality of security events against said positively stated rules;
automatically correlating the security policy with the various security sub-system's policies,
whereby said method enables positive, centralized security monitoring.

10. The method of claim 9, further comprising correlating the plurality of security events from said at least one BAM to create a business process event.

11. The method of claim 9, further comprising adding user transaction content of said at least one BAM to said BAM event to create a content-aware event.

12. The method of claim 10, further comprising adding user transaction content of said at least one BAM to said BAM event to create a content-aware event

13. The method of claim 9, further comprising adding user transaction content of said at least one BAM to MSSMSP to create content-aware monitoring policy.

14. The method of claim 10, further comprising adding user transaction content of said at least one BAM to MSSMSP to create content-aware monitoring policy.

15. The method of claim 9, wherein PMS-SM automatically handles all violations.
